(19) United States
(12) Patent Application Publication
(10) Pub. No.: US 2026/0213077 A1
(43) Pub. Date: Jul. 23, 2026

(54) MULTILAYER CERAMIC CAPACITOR

(71) Applicant: Murata Manufacturing Co., Ltd., Nagaokakyo-shi (JP)

(72) Inventors: Akira ISHIZUKA, Nagaokakyo-shi (JP); Takashi SAWADA, Nagaokakyo-shi (JP)

(21) Appl. No.: 19/566,122

(22) Filed: Mar. 13, 2026

Related U.S. Application Data
(63) Continuation of application No. PCT/JP2024/039381, filed on Nov. 6, 2024.

(30) Foreign Application Priority Data
Dec. 26, 2023 (JP) 2023-219584

(51) Int. Cl. H01G 4/30; H01G 4/012; H01G 4/12

(52) U.S. Cl. CPC H01G 4/30; H01G 4/012; H01G 4/1227

(57) ABSTRACT

A multilayer ceramic capacitor includes a multilayer body, and two end-surface outer electrodes each on a corresponding one of two end surfaces of the multilayer body. The multilayer body includes an inner layer portion, and an outer layer portion on opposite sides of the inner layer portion in the stacking direction. The inner layer portion includes end-surface exposed inner electrodes, and inner dielectric layers. The outer layer portion includes first and second outer layer portions respectively located in a vicinity of first and second major surfaces. The outer layer portion wraps around into a gap region between each end-surface exposed inner electrode and a side surface. An amount of wrap-around of the first outer layer portion into the gap region is greater than an amount of wrap-around of the second outer layer portion into the gap region.

### CROSS REFERENCE TO RELATED APPLICATIONS

This application claims the benefit of priority to Japanese Patent Application No. 2023-219584 filed on Dec. 26, 2023 and is a Continuation Application of PCT Application No. PCT/JP 2024/039381 filed on Nov. 6, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors generally include an inner layer portion in which inner electrodes and dielectric layers are stacked alternately. An outer layer portion is disposed on opposite sides of the inner layer portion in the stacking direction. The inner layer portion includes an effective layer, which contributes to capacitance formation. A gap portion, which does not contribute to capacitance formation, is disposed at the outer periphery portion of the effective layer in a direction orthogonal to the stacking direction. Portions such as the outer layer portion and the gap portion contribute to reliability such as moisture resistance.

In recent years, multilayer ceramic capacitors are increasingly required to be smaller and thinner while also being required to provide greater capacitance. Since the inner layer portion contributes to capacitance formation, there is a limit on how much the inner layer portion can be reduced in size. Therefore, to achieve overall miniaturization and thickness reduction, portions such as the outer layer portion and the gap portion are further reduced in thickness.

Making portions such as the outer layer portion and the gap portion thinner may, however, result in reduced reliability. A related-art technique to address this issue involves providing an insulating layer so as to cover the outer side portion of the outer layer portion (see, for example, Japanese Unexamined Patent Application Publication No. 2023-113923).

However, when an insulating layer covers the outer side portion of the outer layer portion as in the case of the related-art technique described above, an insulating-layer providing step is additionally required. Further, the presence of such an insulating layer increases the thickness of the resulting multilayer body.

### SUMMARY OF THE INVENTION

Example embodiments of the present invention provide multilayer ceramic capacitors that each enable miniaturization and thickness reduction while improving moisture resistance.

An example embodiment of the present invention provides a multilayer ceramic capacitor including a multilayer body, and two end-surface outer electrodes. The multilayer body includes a first major surface and a second major surface that are opposite to each other in a stacking direction, two end surfaces that are opposite to each other in a longitudinal direction intersecting the stacking direction, and two side surfaces that are opposite to each other in a transverse direction, which intersects the stacking direction and the longitudinal direction. The two end-surface outer electrodes are each on a corresponding one of the two end surfaces of the multilayer body. The multilayer body includes an inner layer portion, and an outer layer portion on opposite sides of the inner layer portion in the stacking direction. The inner layer portion includes a plurality of end-surface exposed inner electrodes, and a plurality of inner dielectric layers. The outer layer portion includes a first outer layer portion located in a vicinity of the first major surface, and a second outer layer portion located in a vicinity of the second major surface. The outer layer portion wraps around into a gap region located between each of the plurality of end-surface exposed inner electrodes and each of the two side surfaces. An amount of wrap-around of the first outer layer portion into the gap region is greater than an amount of wrap-around of the second outer layer portion into the gap region.

Another example embodiment of the present invention provides a multilayer ceramic capacitor including a multilayer body, two end-surface outer electrodes, and two side-surface outer electrodes. The multilayer body includes a first major surface and a second major surface that are opposite to each other in a stacking direction, two end surfaces that are opposite to each other in a longitudinal direction intersecting the stacking direction, and two side surfaces that are opposite to each other in a transverse direction, which intersects the stacking direction and the longitudinal direction. The two end-surface outer electrodes are each on a corresponding one of the two end surfaces of the multilayer body. The side-surface outer electrodes are each disposed on a corresponding one of the two side surfaces of the multilayer body. The multilayer body includes an inner layer portion, and an outer layer portion on opposite sides of the inner layer portion in the stacking direction. The outer layer portion includes a first outer layer portion located in a vicinity of the first major surface, and a second outer layer portion located in a vicinity of the second major surface. The inner layer portion includes a plurality of end-surface exposed inner electrodes, a plurality of side-surface exposed inner electrodes, and a plurality of inner dielectric layers. The plurality of end-surface exposed inner electrodes each include an end-surface opposed portion opposed in the stacking direction to a corresponding one of the plurality of side-surface exposed inner electrodes, and an end-surface extended portion extended from the end-surface opposed portion to each of the two end surfaces of the multilayer body. The plurality of side-surface exposed inner electrodes each include a side-surface opposed portion opposed in the stacking direction to a corresponding one of the plurality of end-surface exposed inner electrodes, and a side-surface extended portion extended from the side-surface opposed portion to each of the two side surfaces of the multilayer body. The inner layer portion includes an end-surface extended region in which a plurality of the end-surface extended portions overlap, a side-surface extended region in which a plurality of the side-surface extended portions overlap, and a three-terminal gap region located between each of the plurality of end-surface exposed inner electrodes and each of the two side surfaces, and that does not overlap the side-surface extended region. The outer layer portion wraps around into the three-terminal gap region. An amount of wrap-around of the first outer layer portion into the three-terminal gap region is greater than an amount of wrap-around of the second outer layer portion into the three-terminal gap region.

Example embodiments of the present invention provide multilayer ceramic capacitors that each enable miniaturization and thickness reduction while improving moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a cross-sectional view taken along a line II-II in FIG. 1.

FIG. 3 is a cross-sectional view taken along a line III-III in FIG. 1.

FIG. 4 is an enlarged view of a dashed rectangular region Q illustrated in FIG. 3.

FIG. 5 illustrates a formula for calculating skewness.

FIG. 6 is a schematic perspective view of a multilayer ceramic capacitor 100 according to an example embodiment of the present invention.

FIG. 7 is a cross-sectional view taken along a line V-V in FIG. 6.

FIG. 8 is a cross-sectional view taken along a line VI-VI in FIG. 6.

FIG. 9 is a cross-sectional view taken along a line VII-VII in FIG. 6.

FIG. 10 illustrates an inner layer portion 11 of a multilayer ceramic capacitor 100 according to an example embodiment of the present invention as viewed from a first major surface A1, with dashed lines indicating the respective locations of an end-surface exposed inner electrode 16 and a side-surface exposed inner electrode 17.

### DETAILED DESCRIPTION OF THE EXAMPLE EMBODIMENTS

Example embodiments of the present invention will be described in detail below with reference to the drawings.

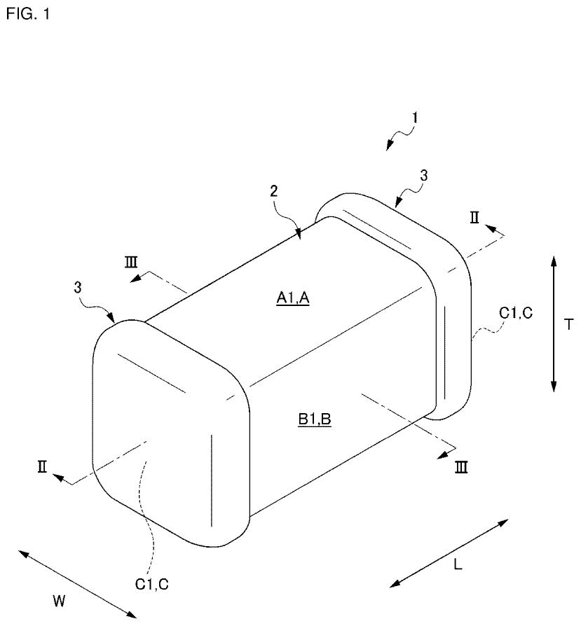

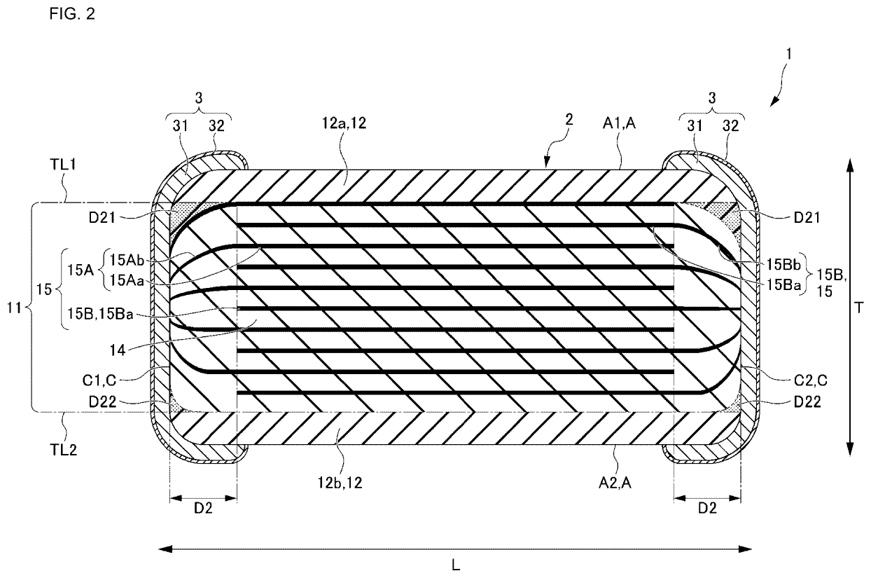

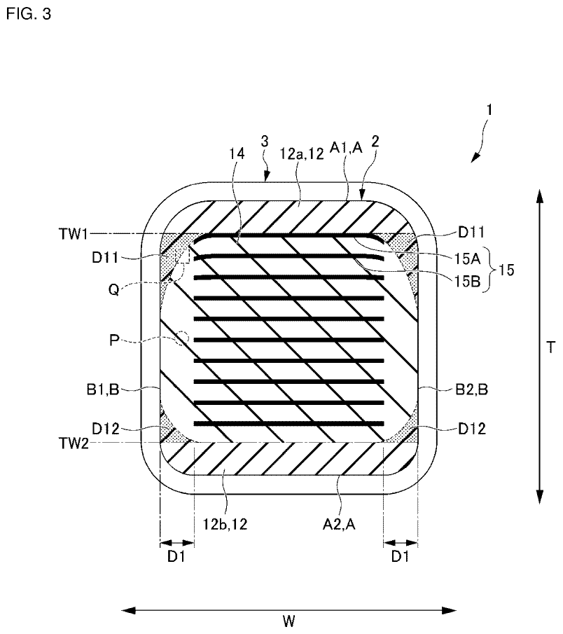

A multilayer ceramic capacitor 1 according to a first example embodiment of the present invention will now be described. The multilayer ceramic capacitor 1 according to the first example embodiment is a two-terminal multilayer ceramic capacitor. FIG. 1 is a schematic perspective view of the multilayer ceramic capacitor 1. FIG. 2 is a cross-sectional view taken along a line II-II in FIG. 1. FIG. 3 is a cross-sectional view taken along a line III-III in FIG. 1.

The multilayer ceramic capacitor 1 is cuboid or substantially cuboid in shape. The multilayer ceramic capacitor 1 includes a multilayer body 2, and a pair of end-surface outer electrodes 3 disposed at opposite ends of the multilayer body 2. The multilayer body 2 includes an inner layer portion 11 and at least one outer layer portion 12. In the inner layer portion 11, a plurality of inner dielectric layers 14 and a plurality of end-surface exposed inner electrodes 15 are stacked.

In the following description, directions associated with the multilayer ceramic capacitor 1 are defined as described below. A direction in which the inner dielectric layer 14 and the end-surface exposed inner electrode 15 are stacked is defined as a stacking direction T. A direction intersecting the stacking direction T and in which the pair of end-surface outer electrodes 3 are disposed is defined as a longitudinal direction L. A direction intersecting both the longitudinal direction L and the stacking direction T is defined as a transverse direction W. According to the present example embodiment, the transverse direction W is orthogonal or substantially orthogonal to both the longitudinal direction L and the stacking direction T.

Hereinafter, of the six outer peripheral surfaces of the multilayer body 2 illustrated in FIG. 2, the pair of outer peripheral surfaces opposite to each other in the stacking direction T will be referred to as a first major surface A1 and a second major surface A2, and the first major surface A1 and the second major surface A2 will be collectively referred to as a major surface A when there is no particular need to distinguish therebetween. The pair of outer peripheral surfaces of the multilayer body 2 that are opposite to each other in the transverse direction W will be referred to as a first side surface B1 and a second side surface B2, and the first side surface B1 and the second side surface B2 will be collectively referred to as a side surface B when there is no particular need to distinguish therebetween. The pair of outer peripheral surfaces of the multilayer body 2 that are opposite to each other in the longitudinal direction L will be referred to as a first end surface C1 and a second end surface C2, and the first end surface C1 and the second end surface C2 will be collectively referred to as an end surface C when there is no particular need to distinguish therebetween.

Both or one of the first major surface A1 and the second major surface A2 is preferably flat. If the major surface A is flat, stress exerted by a nozzle in picking up the multilayer ceramic capacitor 1 can be distributed over the flat major surface A. This makes it possible to improve the strength of the multilayer ceramic capacitor 1 during mounting. This, however, is not intended to be limiting. Alternatively, both of the first major surface A1 and the second major surface A2 of the multilayer body 2 may be rough.

A portion where two of the first major surface A1, the second major surface A2, the first end surface C1, the second end surface C2, the first side surface B1, and the second side surface B2 meet is referred to as an edge, and a portion where three of these faces meet is referred to as a corner. Such edges and corners are preferably rounded. The rounding makes it possible to prevent chipping and cracking. When the edges and corners are rounded, the major surfaces may be flat except at the corners and edges.

The inner layer portion 11 includes the end-surface exposed inner electrodes 15, and the inner dielectric layers 14 stacked alternately with the end-surface exposed inner electrodes 15. The end-surface exposed inner electrodes 15 each preferably have a thickness of, for example, greater than or equal to about 0.25 μm and less than or equal to about 0.6 μm.

The end-surface exposed inner electrodes 15 include a first end-surface exposed inner electrode 15A exposed at one end on the first end surface C1, and a second end-surface exposed inner electrode 15B exposed at one end on the second end surface C2. The first end-surface exposed inner electrode 15A and the second end-surface exposed inner electrode 15B are stacked alternately.

In one non-limiting example, the end-surface exposed inner electrode 15 may be made of any suitable conductive material, examples of which include metals such as Ni, Cu, Ag, Pd, or Au or alloys including at least one of these metals, such as an Ag-Pd alloy. When the end-surface exposed inner electrode 15 includes Sn, this reduces electric field concentration at the interface between the end-surface exposed inner electrode 15 and the inner dielectric layer 14, and leads to improved high-temperature load reliability. In this regard, to achieve the above-described effect, it may suffice that Sn is included only in one of the first end-surface exposed inner electrode 15A and the second end-surface exposed inner electrode 15B.

The first end-surface exposed inner electrode 15A includes a first opposed portion 15Aa opposed to the second end-surface exposed inner electrode 15B, and a first extended portion 15Ab extending from the first opposed portion 15Aa onto the first end surface C1. The second end-surface exposed inner electrode 15B includes a second opposed portion 15Ba opposed to the first end-surface exposed inner electrode 15A, and a second extended portion 15Bb extending from the second opposed portion 15Ba onto the second end surface C2.

The first opposed portion 15Aa and the second opposed portion 15Ba are opposed to each other, and a capacitance is generated between the first opposed portion 15Aa and the second opposed portion 15Ba. This allows the multilayer ceramic capacitor 1 to provide characteristics of a capacitor.

The first opposed portion 15Aa and the second opposed portion 15Ba will be collectively referred to as an opposed portion 15a when there is no particular need to distinguish therebetween. The first extended portion 15Ab and the second extended portion 15Bb will be collectively referred to as an extended portion 15b when there is no particular need to distinguish therebetween.

Each inner dielectric layer 14 includes, for example, barium titanate as a major component, and Si as a minor component. The inner dielectric layer 14 has a thickness of, for example, less than or equal to about 0.45 μm in the stacking direction T.

The inner dielectric layer 14 of the inner layer portion 11 of the multilayer ceramic capacitor 1 includes ceramic grains. The inner dielectric layer 14 preferably, for example, has a ceramic grain size D50 of less than or equal to about 0.15 μm. This makes it possible to increase the number of ceramic grains included in the inner dielectric layer 14. This in turn increases the number of interfaces between ceramic grains, leading to improved high-temperature reliability.

As illustrated in FIG. 3, in the inner layer portion 11, a region between the end-surface exposed inner electrode 15 and the side surface B is referred to as a gap region D1. As illustrated in FIG. 2, a region between the first end-surface exposed inner electrode 15A and the second end surface C2, and a region between the second end-surface exposed inner electrode 15B and the first end surface C1, that is, a region of the inner layer portion 11 where the extended portion 15b exists in the stacking direction T is referred to as an extended region D2.

According to the present example embodiment, the content of Si in the inner dielectric layer 14 located within the gap region D1 and near the center in the stacking direction T is preferably, for example, greater than or equal to about 0.2 atomic percent (at %) and less than or equal to about 5.0 at %.

When the content of Si within the dielectric ceramic material in the gap region D1 is less than about 0.2 at %, it is more difficult for sintering to proceed. According to the present example embodiment, however, the content of Si within the dielectric ceramic material in the gap region D1 is, for example, greater than or equal to about 0.2 at %, which makes it possible to facilitate sintering in the inner dielectric layer 14. In particular, this makes it possible to reduce the possibility of moisture entering through the first side surface B1 and the second side surface B2 that are not covered by the end-surface outer electrode 3 and reaching the end-surface exposed inner electrode 15. Therefore, moisture resistance is improved.

When the content of Si within the dielectric ceramic material in the gap region D1 is greater than about 5.0 at %, the resulting reduction in dielectric constant leads to a pronounced decrease in capacitance. According to the present example embodiment, however, the content of Si within the dielectric ceramic material in the gap region D1 is, for example, less than or equal to about 5.0 at %, and thus the problem of decreased capacitance due to a reduced dielectric constant is less likely to occur.

According to the present example embodiment, the content of Si in the inner dielectric layer 14 located in a vicinity of the center in the stacking direction T of the gap region D1 is, for example, greater than or equal to about 0.2 at % and less than or equal to about 5.0 at %. This, however, is not intended to be limiting. As long as the content of Si in the inner dielectric layer 14 located in a vicinity of the center in the stacking direction T of the gap region D1 is at least greater than or equal to about 0.2 at % and less than or equal to about 5.0 at %, it is possible to reduce the possibility of moisture entering through the first side surface B1 and the second side surface B2 that are not covered by the end-surface outer electrode 3 and reaching the end-surface exposed inner electrode 15.

The content of Si can be measured as described below. For example, in the case of the gap region D1, in the cross-section in FIG. 3 taken in a vicinity of the center in the longitudinal direction L, a region of φ1 μm located about 5 μm outward (toward the side surface B) in the transverse direction W from an end portion of the end-surface exposed inner electrode 15 at substantially the ½ position in the stacking direction T is defined as a region P. The content of Si is calculated from the X-ray intensity spectrum detected within the region P by a wavelength-dispersive X-ray fluorescence spectrometer (WDX).

The multilayer body 2 includes the inner layer portion 11, and two outer layer portions 12 sandwiching the inner layer portion 11 in the stacking direction T. Of the two outer layer portions 12, the outer layer portion 12 near the first major surface A1 is referred to as a first outer layer portion 12a, and the outer layer portion 12 near the second major surface A2 is referred to as a second outer layer portion 12b. The first outer layer portion 12a and the second outer layer portion 12b are each made of an insulating material.

In the multilayer ceramic capacitor 1 according to the present example embodiment, the first outer layer portion 12a and the second outer layer portion 12b are pressed and wrap around into the gap region D1 and the extended region D2.

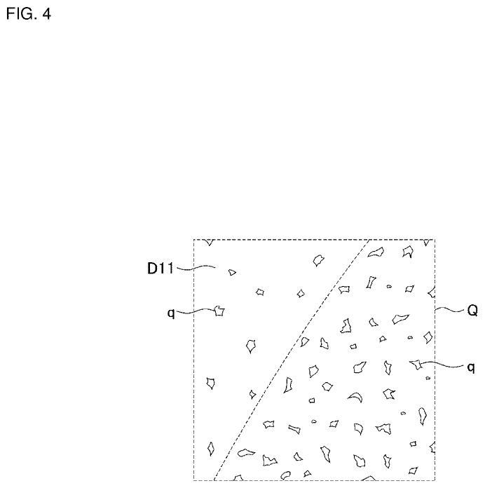

FIG. 4 is an enlarged view of a dashed rectangular region Q illustrated in FIG. 3. The outer layer portion 12 and the gap region D1 both include voids q. The void ratio in the outer layer portion 12 is lower than the void ratio in the gap region D1. A void ratio is the proportion of the area of voids q per unit cross-sectional area. A void ratio is measured by observing an image within an approximately 10-μm-square field of view and converting the observed image into a binary image that separates the voids q from other portions.

The outer layer portion 12 is stacked on both sides of the gap region D1 in the stacking direction T. Therefore, even after firing is performed during manufacture of a multilayer ceramic capacitor, some interface exists between the gap region D1 and the outer layer portion 12. At such an interface, the coupling strength is lower than in other areas. In particular, when a multilayer ceramic capacitor with a conventional structure is miniaturized, the gap region D1 has a reduced dimension in the transverse direction W, which increases the risk of moisture penetrating into the end-surface exposed inner electrode 15 through the interface.

In the multilayer ceramic capacitor 1 according to the present example embodiment, however, the outer layer portion 12 is pressed and wraps around into the gap region D1. The gap region D1 and the outer layer portion 12 are thus pressure-bonded at their interface. This reduces the possibility of external moisture penetrating through the interface into the inner electrode 15. This in turn leads to improved moisture resistance.

As illustrated in FIG. 3, no inner electrode 15 is present in the gap region D1. Therefore, in the gap region D1, the thickness in the stacking direction T decreases by an amount corresponding to the inner electrode 15, in comparison to the corresponding central region where the inner electrode 15 and the inner dielectric layer 14 are stacked. This results in a step being provided between the gap region D1 and the corresponding region.

According to the present example embodiment, the inner dielectric layers 14 each have a thickness of, for example, less than or equal to about 0.45 μm in the stacking direction T. When each single inner dielectric layer 14 is thin as described above, the overall capacitance increases.

However, as the inner dielectric layer 14 becomes thinner relative to the inner electrode 15, the inner electrode 15 occupies a larger proportion of the overall thickness of the opposed portion in the stacking direction T. As a result, the step provided depending on whether the inner electrode 15 is present has a greater effect on the overall thickness of the multilayer body 2 in the stacking direction T. This tends to result in inadequate adhesion, at the location of the step, between the inner dielectric layer 14 and the outer layer portion 12 when a sheet stack is subjected to pressing in the stacking direction T as will be described later.

In this regard, in the multilayer ceramic capacitor 1 according to the present example embodiment, the outer layer portion 12 is pressed and wraps around into the gap region D1. Therefore, the outer layer portion 12 and the gap region D1 are firmly pressure-bonded even at the location of the step. This further reduces the possibility of external moisture penetrating through the interface into the inner electrode 15. This in turn leads to improved moisture resistance.

The outer layer portion 12 wraps around into the gap region D1. The interface between the outer layer portion 12 and the gap region D1 is curved rather than straight, and is long as compared with a case where the outer layer portion 12 does not wrap around into the gap region D1. The above-described configuration also reduces the possibility of external moisture penetrating through the interface into the inner electrode 15. This in turn leads to improved moisture resistance.

According to the present example embodiment, an amount of wrap-around D11 of the first outer layer portion 12a into the gap region D1 is greater than an amount of wrap-around D12 of the second outer layer portion 12b into the gap region D1. In an example, the amount of wrap-around D12 of the second outer layer portion 12b is, for example, less than or equal to about 90% of the amount of wrap-around D11 of the first outer layer portion 12a.

As for the amount of wrap-around D11 of the outer layer portion 12 into the gap region D1, the greater the amount of wrap-around D11, the greater the improvement in moisture resistance. However, as for the amount of wrap-around D12 of the outer layer portion 12 located in a vicinity of one major surface corresponding to the side to be mounted to a substrate (the second outer layer portion 12b according to the present example embodiment), excessively increasing the amount of wrap-around D12 is not preferable as this makes it difficult to maintain flatness during the mounting process.

In this regard, as for the outer layer portion 12 located in a vicinity of the other major surface not corresponding to the side to be mounted to the substrate (the first outer layer portion 12a according to the present example embodiment), increasing the amount of wrap-around D11 does not affect the mounting process. Therefore, the greater the amount of wrap-around D11, the greater the improvement in moisture resistance.

Accordingly, the multilayer ceramic capacitor 1 according to the present example embodiment is configured such that the amount of wrap-around D11 of the first outer layer portion 12a is greater than the amount of wrap-around D12 of the second outer layer portion 12b. This allows for maximum improvement in moisture resistance while maintaining flatness during the mounting process.

The amount of wrap-around D11 of the first outer layer portion 12a into the gap region D1 illustrated in FIG. 3 is greater than an amount of wrap-around D21 of the first outer layer portion 12a into the extended region D2 illustrated in FIG. 2. The amount of wrap-around D12 of the second outer layer portion 12b into the gap region D1 illustrated in FIG. 3 is greater than an amount of wrap-around D22 of the second outer layer portion 12b into the extended region D2 illustrated in FIG. 2.

According to the present example embodiment, the amounts of wrap-around D21 and D22 of the outer layer portions 12 into the extended region D2 are smaller than the amounts of wrap-around D11 and D12 of the outer layer portions 12 into the gap region D1, respectively. The above-described configuration makes it possible to prevent an excessive increase in the length of the current path extending to the extended region D2 from a mounting land on which the multilayer ceramic capacitor is to be mounted. The above-described configuration therefore allows for improved reliability against moisture without greatly increasing equivalent series inductance (ESL).

The amounts of wrap-around D11 and D12 of the outer layer portions 12 into the gap region D1 are defined as described below. First, in the cross-section illustrated in FIG. 3, the following two mutually parallel or substantially parallel straight lines are drawn: a straight line TW1 extending in the transverse direction W from the outermost surface of the inner electrode 15 located closest to the first major surface A1, and a straight line TW2 extending in the transverse direction W from the outermost surface of the inner electrode 15 located closest to the second major surface A2.

Then, the following two mutually parallel or substantially parallel lines orthogonal or substantially orthogonal to the straight lines TW1 and TW2 are drawn: a straight line passing through an end portion in the transverse direction W of each inner electrode 15, and a straight line passing through an end portion in the transverse direction W of the multilayer body 2. Within the region bounded by the four straight lines described above, the area of a portion of the first outer layer portion 12a extending into the gap region D1 is defined as the amount of wrap-around D11 of the first outer layer portion 12a into the gap region D1.

Similarly, the area of a portion of the second outer layer portion 12b that is located within the gap region D1 is defined as the amount of wrap-around D12 of the second outer layer portion 12b into the gap region D1.

The amounts of wrap-around D21 and D22 of the outer layer portions 12 into the extended region D2 are defined as described below. First, in the cross-section illustrated in FIG. 2, the following two mutually parallel or substantially parallel straight lines are drawn: a straight line TL1 extending in the longitudinal direction L from the outermost surface of the inner electrode 15 located closest to the first major surface A1, and a straight line TL2 extending in the longitudinal direction L from the outermost surface of the inner electrode 15 located closest to the second major surface A2.

Then, the following two mutually parallel or substantially parallel lines orthogonal or substantially orthogonal to the straight lines TL1 and TL2 are drawn: a straight line passing through an end portion in the longitudinal direction L of each inner electrode 15, and a straight line passing through an end portion in the longitudinal direction L of the multilayer body 2. Within the region bounded by the four straight lines described above, the area of a portion of the first outer layer portion 12a extending into the extended region D2 is defined as the amount of wrap-around D21 of the first outer layer portion 12a into the extended region D2.

Similarly, the area of a portion of the second outer layer portion 12b extending into the extended region D2 is defined as the amount of wrap-around D22 of the second outer layer portion 12b into the extended region D2.

The boundary between the outer layer portion 12 and the inner dielectric layer 14 can be detected by, for example, observation with a field-emission electron probe microanalyzer (FE-WDX) or the like. In one example, when the amount of Si included in the inner dielectric layer 14 located in the gap region D1 differs from the amount of Si included in the outer layer portion 12, the boundary between the outer layer portion 12 and the inner dielectric layer 14 can be detected from the segregation of Si observed by FE-WDX or the like. In another example, the boundary between the outer layer portion 12 and the inner dielectric layer 14 can be also detected from the difference in void ratio between the outer layer portion 12 and the inner dielectric layer 14.

According to the present example embodiment, the outer layer portion 12 includes, for example, barium titanate as a major component, and Si and Mn as minor components.

According to the present example embodiment, the skewness of Si included in the outer layer portion 12 and in the inner dielectric layer 14 within the gap region D1 is preferably, for example, greater than or equal to about 0 and less than or equal to about 0.5. This makes it possible to improve moisture resistance without adversely affecting high-temperature reliability. Since the above-described configuration makes it possible to reduce the possibility of moisture entering through the outer layer portion 12 and the first and second side surfaces B1 and B2 and reaching the end-surface exposed inner electrode 15, moisture resistance improves.

The skewness of Si is calculated by a method described below.

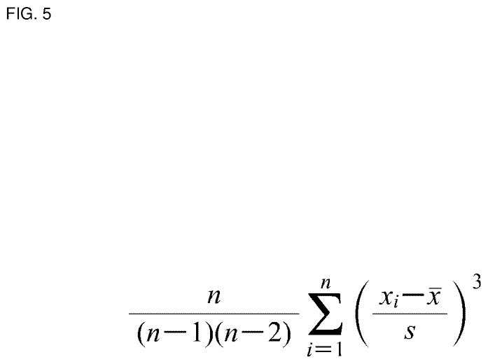

First, the multilayer ceramic capacitor 1 is cross-sectionally polished to the position illustrated in FIG. 3, and the detected X-ray intensity of Si in each grid cell is measured by WDX. More specifically, a approximately 5-μm-square observation field of view is divided into 38×38 grid cells, and the content of Si is measured from the X-ray intensity spectrum in each grid cell. Then, the formula in FIG. 5 is used to compute the skewness of Si. The formula in FIG. 5 can also be calculated automatically. The formula in FIG. 5 indicates how much a distribution is skewed from the normal distribution, and represents a measure of the symmetry of the distribution. In the formula, n denotes sampling size, x denotes the mean of data xi (i: 1, 2, 3 . . . , n), and s denotes standard deviation.

Further, the skewness of Si included in the inner dielectric layer 14 within the gap region D1 is greater than the skewness of Si contained in the outer layer portion 12. That is, the particles of Si included in the inner dielectric layer 14 within the gap region D1 have greater variations in size than the particles of Si included in the outer layer portion 12. In other words, the particles of Si included in the outer layer portion 12 are more uniform in size than the particles of Si included in the inner dielectric layer 14 within the gap region D1. In still other words, the segregation of Si included in the inner dielectric layer 14 within the gap region D1 is more pronounced than the segregation of Si included in the outer layer portion 12.

The skewness of Si included in the inner dielectric layer 14 within the gap region D1 is preferably, for example, greater by about 0.5% or more than the skewness of Si included in the outer layer portion 12.

The greater the skewness of Si, the greater the improvement in moisture resistance, and thus the greater the improvement in the moisture resistance of the inner dielectric layer 14.

Further, according to the present example embodiment, the content of Mn in the outer layer portion 12 is greater than the content of Mn in the inner dielectric layer 14 located within the gap region D1 and in a vicinity of the center in the stacking direction T. This makes it possible to further improve the high-temperature reliability of the outer layer portion 12.

Increasing the content of Mn in the outer layer portion 12 makes it possible to improve the denseness of the outer layer portion, and thus improve the reliability against moisture.

In this regard, improving the reliability against moisture only in the outer layer by using Mn as described above results in a relatively high void ratio and a decreased moisture resistance in the gap region D1. To address this, in the gap region D1, the reliability against moisture is improved by the segregation of Si.

The end-surface outer electrodes 3 include a first end-surface outer electrode 3A and a second end-surface outer electrode 3B. The first end-surface outer electrode 3A is connected to the first end-surface exposed inner electrode 15A, and disposed on the first end surface C1. The first end-surface outer electrode 3A also includes a fold-back portion extending to a portion of the major surface and to a portion of the side surface B. The second end-surface outer electrode 3B is connected to the second end-surface exposed inner electrode 15B, and disposed on the second end surface C2. The second end-surface outer electrode 3B also includes a fold-back portion extending to a portion of the major surface and to a portion of the side surface B. Hereinafter, the first end-surface outer electrode 3A and the second end-surface outer electrode 3B will be collectively referred to as the end-surface outer electrode 3 when there is no particular need to distinguish therebetween.

The end-surface outer electrode 3 includes a base electrode layer 31, and a plating layer 32 disposed on the base electrode layer 31. The base electrode layer 31 includes, for example, a metal and a glass component. Examples of the metal include at least one of copper, nickel, silver, palladium, a silver-palladium alloy, or gold. According to the present example embodiment, the metal is gold, for example. Examples of the glass component include boron or silicon. The plating layer 32 may include, for example, a Ni (nickel) plating layer disposed on the base electrode layer 31, and a Sn (tin) plating layer disposed on the Ni plating layer.

The skewness of Si within the outer layer portion 12 and the skewness of Si within the gap region D1 can be made different from each other by the difference in the particle size of Si-containing particles to be included in the dielectric paste, for example, glass particles, between the dielectric paste used for forming the outer layer portion and the dielectric paste used for forming the inner dielectric layers.

Specifically, in the dielectric paste used for the inner dielectric layer, the particle size of glass particles defining and functioning as reference glass particles is set to be, for example, greater than or equal to about 0.005 μm and less than or equal to about 0.5 μm, and glass particles with a particle size larger than that of the reference glass particles by, for example, about 1.0 μm are mixed at a content greater than or equal to about 0.01 Vol % and less than or equal to about 40 Vol % into the dielectric paste used for forming the inner dielectric layers. The particle size of glass particles to be included in the dielectric paste used for forming the outer layer portion is set to be, for example, greater than or equal to about 0.005 μm and less than or equal to about 0.5 μm.

Then, on top of dielectric sheets produced by using the dielectric paste used for forming the inner dielectric layers, a conductive paste used for forming the inner electrodes is applied in, for example, a predetermined pattern. An inner electrode pattern is thus formed on the corresponding dielectric sheet. The inner electrode pattern can be formed by a method such as screen printing or gravure printing, for example.

Subsequently, a predetermined number of dielectric sheets for the second outer layer portion, which are dielectric sheets produced by using the dielectric paste used for forming the outer layer portion, are stacked. On top of the stack, dielectric sheets used for forming the inner layer portion and provided with an inner electrode pattern are stacked sequentially. Further, on top of the resulting stack, a predetermined number of dielectric sheets for the first outer layer portion, which are dielectric sheets produced by using the dielectric paste used for forming the outer layer portion, are stacked. A sheet stack is thus produced.

Subsequently, the sheet stack is pressed in the stacking direction T by, for example, isostatic pressing or the like to thus produce a multilayer block.

In performing the isostatic pressing, for example, rubber is positioned to sandwich the sheet stack in the stacking direction T such that the rubber is thicker in a portion that is to be placed between mutually adjacent multilayer bodies 2 than in other portions. Performing pressing in this state allows the outer layer portion 12 to wrap around into the gap region D1 and the extended region D2.

Then, during the isostatic pressing process, rubber whose hardness and thickness differ between a portion in a vicinity of the first major surface A1 and a portion in a vicinity of the second major surface A2 is used in performing the pressing. This allows the amount of wrap-around of the first outer layer portion 12a to be greater than the amount of wrap-around of the second outer layer portion 12b. For example, when the rubber is made harder in a portion near the second major surface A2, this makes it impossible to sufficiently press areas near the second major surface A2. The amount of flow can be thus controlled.

In this regard, the amount of flow can be varied also by, for example, performing temporary pressing after a plurality of layers are stacked at the stacking step, and then making areas near the second major surface A2 harder.

With regard to the method for making the outer layer portion 12 wrap around into the gap region D1 and the extended region D2, and making the amount of wrap-around of the first outer layer portion 12a greater than the amount of wrap-around of the second outer layer portion 12b at this time, not only the method described above but also other methods may be used.

Subsequently, the multilayer block is cut into portions of a predetermined size to obtain each individual multilayer chip.

Then, the multilayer chip is fired to produce the multilayer body 2. Although depending on the material of the dielectric or the end-surface exposed inner electrode 15, the firing temperature is preferably, for example, higher than or equal to about 900° C. and lower than or equal to about 1400° C.

Subsequently, by the dipping method, the first end surface C1 of the multilayer body 2 is dipped into a conductive paste that defines and functions as an electrode material used for forming the base electrode layer 31. The conductive paste used for forming the base electrode layer 31 is thus applied onto the first end surface C1. Similarly, the second end surface C2 of the multilayer body 2 is dipped into a conductive paste that defines and functions as an electrode material used for forming the base electrode layer 31. The conductive paste used for forming the base electrode layer 31 is thus applied onto the second end surface C2. These conductive pastes are then fired to form the base electrode layer 31 as a fired layer. The firing temperature is preferably, for example, higher than or equal to about 600° C. and lower than or equal to about 900° C.

The plating layer 32 is then formed on the surface of the base electrode layer 31 to form the end-surface outer electrode 3. The multilayer ceramic capacitor 1 according to the present example embodiment is thus obtained through the steps described above.

A multilayer ceramic capacitor 100 according to a second example embodiment of the present invention will now be described. The multilayer ceramic capacitor 100 according to the second example embodiment is a three-terminal multilayer ceramic capacitor 100. Hereinafter, features of the multilayer ceramic capacitor 100 according to the second example embodiment the same as or similar to those of the multilayer ceramic capacitor 1 according to the first example embodiment are denoted by the same reference signs, and are not described in further detail.

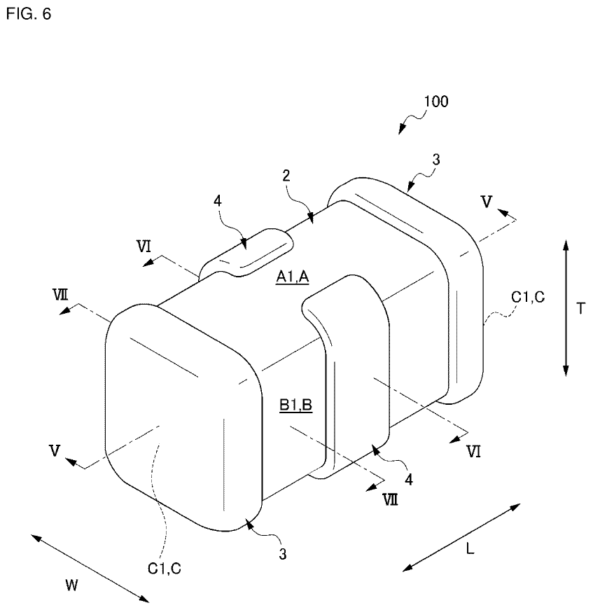

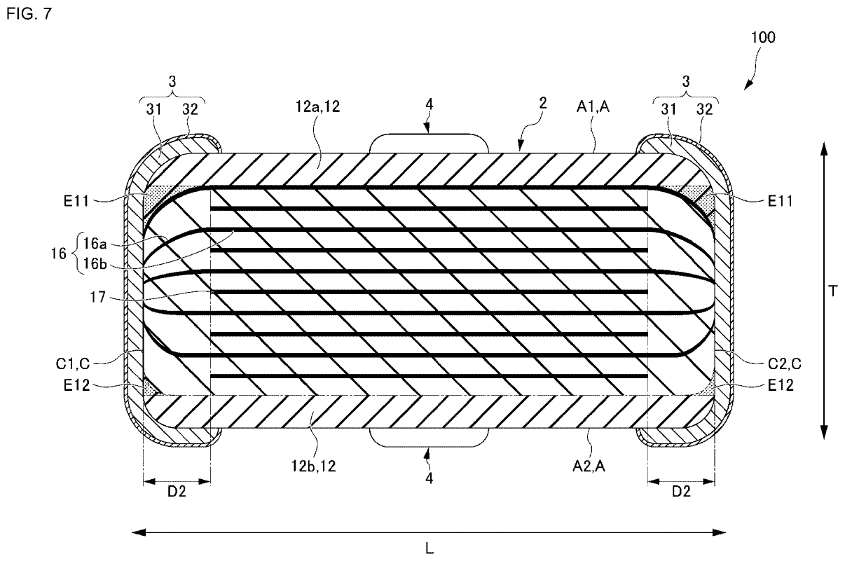

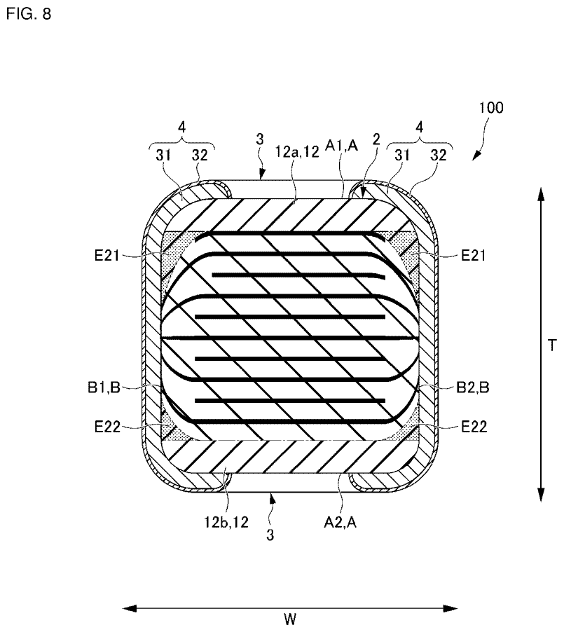

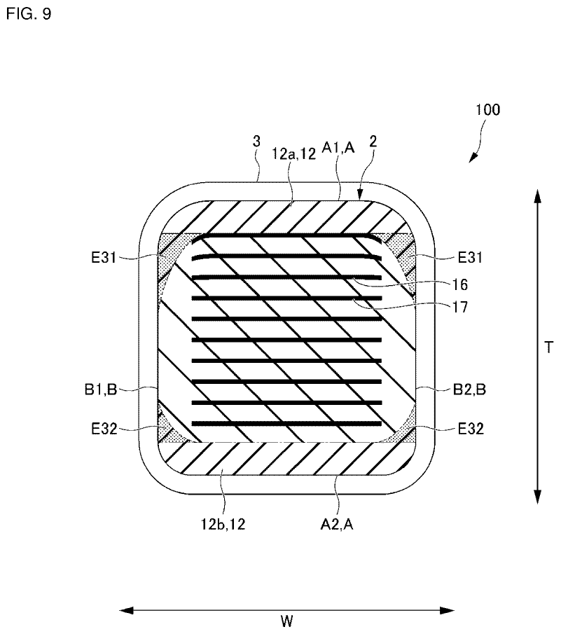

FIG. 6 is a schematic perspective view of the multilayer ceramic capacitor 100. FIG. 7 is a cross-sectional view taken along a line V-V in FIG. 6. FIG. 8 is a cross-sectional view taken along a line VI-VI in FIG. 6. FIG. 9 is a cross-sectional view taken along a line VII-VII in FIG. 6.

The multilayer ceramic capacitor 100 is cuboid or substantially cuboid in shape. The multilayer ceramic capacitor 100 includes at least one side-surface outer electrode 4 in addition to the pair of end-surface outer electrodes 3 disposed at opposite ends of the multilayer body 2.

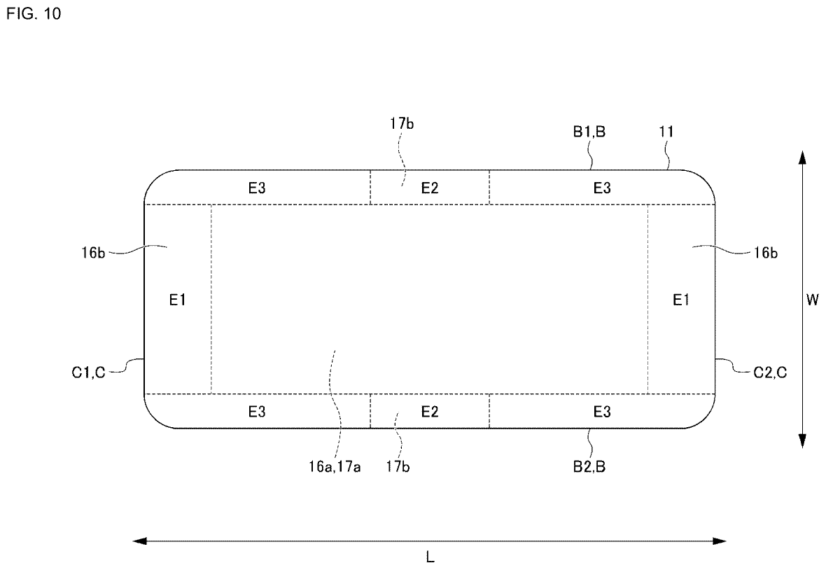

The inner layer portion 11 includes at least one end-surface exposed inner electrode 16, and at least one side-surface exposed inner electrode 17. FIG. 10 illustrates the inner layer portion 11 of the multilayer ceramic capacitor 100 as viewed from the first major surface A1, with dashed lines indicating the respective locations of the end-surface exposed inner electrode 16 (16a, 16b) and the side-surface exposed inner electrode 17 (17a, 17b).

The end-surface exposed inner electrode 16 extends between the opposite end surfaces C in the longitudinal direction L of the multilayer body 2, and is spaced apart by a predetermined distance from the opposite side surfaces B in the transverse direction W. The end-surface exposed inner electrode 16 includes an end-surface opposed portion 16a, which is located centrally between the opposite end surfaces C, and an end-surface extended portion 16b, which extends from the end-surface opposed portion 16a to the opposite end surfaces C. The end-surface extended portion 16b extends to each end surface C such that the end-surface extended portion 16b is exposed on the end surface C of the multilayer body 2, and connected to the end-surface outer electrode 3 disposed on each end surface in the longitudinal direction L of the multilayer body 2.

In the end-surface exposed inner electrode 16, the end-surface opposed portion 16a has a dimension in the transverse direction W less than a dimension in the transverse direction of the end-surface extended portion 16b. The end-surface extended portion 16b may be tapered such that its width (dimension in the longitudinal direction L) gradually decreases from the location where the end-surface extended portion 16b connects with the end-surface opposed portion 16a.

The side-surface exposed inner electrode 17 extends between the opposite side surfaces B in the transverse direction W of the multilayer body 2, and is spaced apart from the opposite end surfaces C in the longitudinal direction L. The side-surface exposed inner electrode 17 includes a side-surface opposed portion 17a, which is located centrally between the opposite side surfaces B, and a side-surface extended portion 17b, which extends from the side-surface opposed portion 17a to the opposite side surfaces B. In a non-limiting example, the side-surface extended portion 17b has a dimension in the longitudinal direction L less than a dimension in the longitudinal direction L of the side-surface opposed portion 17a. The side-surface extended portion 17b extends to each side surface B such that the side-surface extended portion 17b is exposed on the side surface B of the multilayer body 2, and connected to the side-surface outer electrode 4 disposed on each side surface in the transverse direction W of the multilayer body 2.

Returning now to FIGS. 6, 7, and 8, the end-surface opposed portion 16a of the end-surface exposed inner electrode 16 and the side-surface opposed portion 17a of the side-surface exposed inner electrode 17 are opposed to each other, and a capacitance is generated between the end-surface opposed portion 16a and the side-surface opposed portion 17a. This allows the multilayer ceramic capacitor 100 to provide characteristics of a capacitor.

The end-surface outer electrodes 3 are each disposed on the corresponding one of the opposite end surfaces C of the multilayer body 2. The end-surface extended portion 16b of the end-surface exposed inner electrode 16 is connected to the end-surface outer electrode 3. The end-surface outer electrode 3 covers not only the end surface C but also a portion of the major surface A near the end surface C and a portion of the side surface B near the end surface C.

The side-surface outer electrodes 4 are each disposed on the corresponding one of the opposite side surfaces B of the multilayer body 2. The side-surface extended portion 17b of the side-surface exposed inner electrode 17 is connected to the side-surface outer electrode 4. The side-surface outer electrode 4 covers not only the side surface B but also a portion of the major surface A in a vicinity of the side surface B.

Now, as illustrated in FIG. 10, a region where the end-surface extended portions 16b are stacked in the inner layer portion 11 is defined as an end-surface extended region E1. A region where the side-surface extended portions 17b are stacked is defined as a side-surface extended region E2. A region located between the end-surface exposed inner electrode 16 and the side surface B and excluding the side-surface extended region E2 is defined as a three-terminal gap region E3.

According to the present example embodiment, the outer layer portion 12 wraps around into the three-terminal gap region E3, the end-surface extended region E1, and the side-surface extended region E2.

As illustrated in FIG. 9, in the three-terminal gap region E3, an amount of wrap-around E31 of the first outer layer portion 12a is greater than an amount of wrap-around E32 of the second outer layer portion 12b. As illustrated in FIG. 7, in the end-surface extended region E1, an amount of wrap-around E11 of the first outer layer portion 12a is greater than an amount of wrap-around E12 of the second outer layer portion 12b. Further, as illustrated in FIG. 8, in the side-surface extended region E2, an amount of wrap-around E21 of the first outer layer portion 12a is greater than an amount of wrap-around E22 of the second outer layer portion 12b.

The amount of wrap-around E31, as illustrated in FIG. 9, of the first outer layer portion 12a into the three-terminal gap region E3 is greater than the amount of wrap-around E11, as illustrated in FIG. 7, of the first outer layer portion 12a into the end-surface extended region E1, or the amount of wrap-around E21, as illustrated in FIG. 8, of the first outer layer portion 12a into the side-surface extended region E2.

The amount of wrap-around E32, as illustrated in FIG. 9, of the second outer layer portion 12b into the three-terminal gap region E3 is greater than the amount of wrap-around E12, as illustrated in FIG. 7, of the second outer layer portion 12b into the end-surface extended region E1, or the amount of wrap-around E22, as illustrated in FIG. 8, of the second outer layer portion 12b into the side-surface extended region E2.

As described above, as with the first example embodiment, the multilayer ceramic capacitor 100 according to the second example embodiment can provide advantageous effects described below.

That is, the outer layer portion 12 is pressed so as to wrap around into the three-terminal gap region E3, the end-surface extended region E1, and the side-surface extended region E2. Consequently, each of the three-terminal gap region E3, the end-surface extended region E1, and the side-surface extended region E2 is pressure-bonded with the outer layer portion 12 at its interface with the outer layer portion 12. This reduces the possibility of external moisture penetrating through the interface into the inner electrodes 16 and 17. This in turn leads to improved moisture resistance.

Further, the amount of wrap-around of the first outer layer portion 12a is greater than the amount of wrap-around of the second outer layer portion 12b. This allows for maximum improvement in moisture resistance while maintaining flatness during the mounting process.

The amount of wrap-around of the outer layer portion 12 into each of the end-surface extended region E1 and the side-surface extended region E2 is less than the amount of wrap-around of the outer layer portion 12 into the three-terminal gap region E3. This makes it possible to prevent an excessive increase in the length of the current path from the mounting land to the end-surface extended region E1 and the side-surface extended region E2. The above-described configuration therefore enables improved reliability against moisture without greatly increasing equivalent series inductance (ESL).

Although example embodiments of the present invention have been described above, it is to be understood that the present invention is not limited to the example embodiments described above and may include various changes and modifications described below.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
a first major surface and a second major surface opposite to each other in a stacking direction;
two end surfaces opposite to each other in a longitudinal direction intersecting the stacking direction; and
two side surfaces opposite to each other in a transverse direction intersecting the stacking direction and the longitudinal direction; and
two end-surface outer electrodes each on a corresponding one of the two end surfaces of the multilayer body; wherein
the multilayer body includes:
an inner layer portion; and
an outer layer portion on opposite sides of the inner layer portion in the stacking direction;
the inner layer portion includes:
a plurality of end-surface exposed inner electrodes; and
a plurality of inner dielectric layers;
the outer layer portion includes:
a first outer layer portion located in a vicinity of the first major surface; and
a second outer layer portion located in a vicinity of the second major surface;
the outer layer portion wraps around into a gap region located between each of the plurality of end-surface exposed inner electrodes and each of the two side surfaces; and
an amount of wrap-around of the first outer layer portion into the gap region is greater than an amount of wrap-around of the second outer layer portion into the gap region.

2. The multilayer ceramic capacitor according to claim 1, wherein the amount of wrap-around of the second outer layer portion into the gap region is less than or equal to about 90% of the amount of wrap-around of the first outer layer portion into the gap region.

3. The multilayer ceramic capacitor according to claim 1, wherein a content of Si within a portion of the gap region located in a vicinity of a center of the gap region in the stacking direction is greater than or equal to about 0.2 at % and less than or equal to about 5.0 at %.

4. The multilayer ceramic capacitor according to claim 1, wherein a content of Mn in the outer layer portion is greater than a content of Mn within a portion of the gap region located in a vicinity of a center of the gap region in the stacking direction.

5. The multilayer ceramic capacitor according to claim 1, wherein
the plurality of end-surface exposed inner electrodes each include:
an opposed portion opposed in the stacking direction to an adjacent one of the plurality of end-surface exposed inner electrodes; and
an extended portion extending from the opposed portion to one of the two end surfaces;
the multilayer body includes an extended region in which the extended portion is located in the stacking direction;
the outer layer portion wraps around into the extended region; and
the amount of wrap-around of the first outer layer portion into the gap region is greater than an amount of wrap-around of the first outer layer portion into the extended region.

6. The multilayer ceramic capacitor according to claim 1, wherein the plurality of inner dielectric layers each have a ceramic grain size D50 of less than or equal to about 0.15 μm.

7. The multilayer ceramic capacitor according to claim 1, wherein the plurality of inner dielectric layers each have a thickness less than or equal to about 0.45 μm in the stacking direction.

8. The multilayer ceramic capacitor according to claim 1, wherein the outer layer portion has a void ratio lower than a void ratio of the gap region or the three-terminal gap region.

9. The multilayer ceramic capacitor according to claim 1, wherein each of the plurality of end-surface exposed inner electrodes includes Ni, Cu, Ag, Pd, or Au or alloys including at least one of Ni, Cu, Ag, Pd, or Au.

10. The multilayer ceramic capacitor according to claim 1, wherein each of the plurality of end-surface exposed inner electrodes has a thickness of greater than or equal to about 0.25 μm and less than or equal to about 0.6 μm.

11. The multilayer ceramic capacitor according to claim 1, wherein each of the plurality of inner dielectric layers includes barium titanate as a major component and Si as a minor component.

12. A multilayer ceramic capacitor comprising:
a multilayer body including:
a first major surface and a second major surface opposite to each other in a stacking direction;
two end surfaces opposite to each other in a longitudinal direction intersecting the stacking direction; and
two side surfaces opposite to each other in a transverse direction, the transverse direction intersecting the stacking direction and the longitudinal direction;
two end-surface outer electrodes each on a corresponding one of the two end surfaces of the multilayer body; and
two side-surface outer electrodes each on a corresponding one of the two side surfaces of the multilayer body; wherein
the multilayer body includes:
an inner layer portion; and
an outer layer portion on opposite sides of the inner layer portion in the stacking direction;
the outer layer portion includes:
a first outer layer portion located in a vicinity of the first major surface; and
a second outer layer portion located in a vicinity of the second major surface;
the inner layer portion includes:
a plurality of end-surface exposed inner electrodes;
a plurality of side-surface exposed inner electrodes; and
a plurality of inner dielectric layers;
the plurality of end-surface exposed inner electrodes each include:
an end-surface opposed portion opposed in the stacking direction to a corresponding one of the plurality of side-surface exposed inner electrodes; and
an end-surface extended portion extending from the end-surface opposed portion to each of the two end surfaces of the multilayer body;
the plurality of side-surface exposed inner electrodes each include:
a side-surface opposed portion opposed in the stacking direction to a corresponding one of the plurality of end-surface exposed inner electrodes; and
a side-surface extended portion extending from the side-surface opposed portion to each of the two side surfaces of the multilayer body;
the inner layer portion includes:
an end-surface extended region in which a plurality of the end-surface extended portions overlap;
a side-surface extended region in which a plurality of the side-surface extended portions overlap; and
a three-terminal gap region located between each of the plurality of end-surface exposed inner electrodes and each of the two side surfaces, and that does not overlap the side-surface extended region;
the outer layer portion wraps around into the three-terminal gap region; and
an amount of wrap-around of the first outer layer portion into the three-terminal gap region is greater than an amount of wrap-around of the second outer layer portion into the three-terminal gap region.

13. The multilayer ceramic capacitor according to claim 12, wherein
the outer layer portion wraps around into the end-surface extended region and the side-surface extended region; and
an amount of wrap-around of the outer layer portion into the three-terminal gap region is greater than an amount of wrap-around of the outer layer portion into the end-surface extended region or the side-surface extended region.

14. The multilayer ceramic capacitor according to claim 12, wherein the plurality of inner dielectric layers each have a ceramic grain size D50 of less than or equal to about 0.15 μm.

15. The multilayer ceramic capacitor according to claim 12, wherein the plurality of inner dielectric layers each have a thickness less than or equal to about 0.45 μm in the stacking direction.

16. The multilayer ceramic capacitor according to claim 12, wherein the outer layer portion has a void ratio lower than a void ratio of the gap region or the three-terminal gap region.

17. The multilayer ceramic capacitor according to claim 12, wherein each of the plurality of end-surface exposed inner electrodes includes Ni, Cu, Ag, Pd, or Au or alloys including at least one of Ni, Cu, Ag, Pd, or Au.

18. The multilayer ceramic capacitor according to claim 12, wherein each of the plurality of end-surface exposed inner electrodes has a thickness of greater than or equal to about 0.25 μm and less than or equal to about 0.6 μm.

19. The multilayer ceramic capacitor according to claim 12, wherein each of the plurality of inner dielectric layers includes barium titanate as a major component and Si as a minor component.
